(19) United States
(12) Patent Application Publication
(10) Pub. No.: US 2015/0009029 A1
(43) Pub. Date: Jan. 8, 2015

(54) Infant Monitor System and Method

(71) Applicant: Healthcare Zoo, Los Angeles, CA (US)

(72) Inventor: Douglas Martin, Cheyenne, WY (US)

(21) Appl. No.: 13/935,485

(22) Filed: Jul. 4, 2013

(51) Int. Cl. G08B 21/02

(52) U.S. Cl. CPC G08B 21/0202
USPC 340/539.15

(57) ABSTRACT

The invention is a system and method for monitoring the breathing and movement of an infant. The invention is a baby monitor system comprising an infant sensor, a base unit, and a parent unit. The infant sensor is attached to the clothing of the infant. As the infant moves or breaths, a transducer in the infant sensor generates a signal which is relayed by the infant sensor to the base. If the base fails to receive a signal from the infant sensor then the base sends an alarm signal to the parent unit. The system may contain multiple parent units or multiple infant sensors. Furthermore, the system may utilize a server computer. The base sends information to a server computer which may be retrieved through the internet by a user on a client computer.

### FIELD OF THE INVENTION

This invention relates generally to baby monitors and more specifically to a baby monitoring system and method for detecting the movement of a baby and notifying a caregiver of the motion of a baby.

### BACKGROUND OF THE INVENTION

Baby monitors are known in the art. Such monitors usually comprise a video camera or a microphone that is placed in the vicinity of an infant. The video camera or the microphone then sends a signal to a remote monitor that is in the vicinity of the parent or caregiver. These monitors simply reproduce the sound or image received by the camera or microphone that is in the vicinity of the baby. Most of these types of baby monitors are limited in that they rely solely on caregivers to actively watch or listen to the monitor. These monitors are also limited in that they fail to provide an alarm if the infant fails to move or fails to make a sound.

Other types of baby monitors use motion sensors to track the movement of an infant. U.S. Pat. No. 8,094,013 to Lee et al. discloses a baby monitor system utilizing a belt containing two tri-axial accelerometers which is attached to the infant. The accelerometers track the motion of the infant and also will monitor the position of the infant—whether the infant is face down or face up. This information is relayed from an infant sensor unit to a nursery unit. The information is further relayed from the nursery unit to a parent unit. However, the prior art fails to teach a baby monitor which can further relay information to parents or related individuals who are not physically present within the vicinity of the nursery unit or parent unit.

The prior art is also limited in that the prior art does not account for the need or desire to notify more than one caregiver. The prior art discloses a system where a unit placed in a nursery will send a notification signal to an individual parent unit but does not disclose any system that will send a notification signal to more than one parent unit. Such a system is an improvement over the prior art in that both parents will get notifications of any problems that arise. This allows both parents to attend to the infant and increases the likelihood that any problems with the infant may be remedied. Likewise, the prior art fails to disclose systems that receive information from more than one infant. Such a system is necessary where parents have twins or triplets and desire to monitor the breathing and movement of all infants.

It is an object of the invention that parents and caregivers who are not within the physical vicinity of the infant may gain access to information regarding the breathing and movement of the infant. This is beneficial for many of the working parents who want to be sure that their infant is safe while a nonparent caregiver is caring for the infant.

In addition, respiratory pauses and apnea in sleeping infants may occur naturally. Such respiratory pauses may last naturally up to fifteen seconds in time. Respiratory pauses longer than fifteen seconds may be an indication of a problem with the infant. The causes of these respiratory pauses are primarily neurological. An infant can be prompted to begin breathing again through a physical and/or auditory stimulus. This stimulus may be provided by a vibrating device within an infant sensor attached to the infant or an auditory alarm or beep from the infant sensor. This stimulus prompts a neurological response in the infant and can prompt the infant to begin breathing. It is an object of the invention that the baby monitor prompts the infant to begin breathing with a stimulus in the event that the baby monitor determines that the infant has failed to breath or move for more than fifteen seconds.

What is needed is a baby monitor system which provides a warning to multiple caregivers. What is needed is a baby monitor system which obtains information regarding the breathing and movement of multiple infants. What is further needed is a baby monitor system which is accessible by means of any web-enabled device by parents who are not within the physical vicinity of the infant. What is needed is a baby monitor system which can prompt a baby to begin breathing in the event that the baby has failed to breath for more than fifteen seconds due to neurologically based respiratory pauses.

### SUMMARY OF THE INVENTION

The invention is a system for monitoring an infant comprising a first infant sensor, a base, and a first parent unit. The first infant sensor comprises a power source, a transducer, a sensor processor, and a transceiver. The base comprises a transceiver, a base memory unit, a base processor, and a housing. The first parent unit comprises a power source, a transceiver, and a parent processor. In the invention, the first infant sensor is removably attached to the infant, the first infant sensor generates information related to the breathing and movement of an infant, the first infant sensor transmits the information to the base, the base generates an alarm signal if the information indicates that the infant is not moving or breathing, and the base transmits the alarm signal to the first parent unit. In another embodiment of the invention, the first infant sensor further comprises a memory unit, the base further comprises a power source, and the first parent unit further comprises a light indicator, a speaker, and a vibration generator. In this embodiment, when the alarm signal is received by the parent processor, the parent processor activates the speaker in the parent unit to emit a sound, the light indicator in the parent unit to activate, and the vibration generator in the parent unit to vibrate. In another embodiment of the invention, the first infant sensor further comprises a speaker and a vibration generator, the base further comprises a speaker and a light indicator. In this embodiment, if the sensor processor determines that the infant has not breathed or moved for at least fifteen seconds, the sensor processor activates the speaker to create an audible noise and activates the vibration generator to vibrate. Also, the alarm signal causes the base processor to activate the speaker in the base to emit an audible sound and the light indicator in the base to activate. In another embodiment of the invention, the first infant sensor further comprises a light indicator. In this embodiment, if the sensor processor determines that the infant has not breathed or moved for at least fifteen seconds, the sensor processor activates the light indicator. In another embodiment, the base further comprises an infant sensor receptor.

In another embodiment of the invention, the invention further comprises a second infant sensor, a second parent unit, a server computer, a database connected to the server computer, and a client computer. In this embodiment, the second infant sensor is identical in structure to the first infant sensor. The second infant sensor generates information related to the breathing and movement of a second infant. The second infant sensor transmits the information to the base. The base generates an alarm signal if the information indicates that the infant is not moving or breathing and transmits the alarm signal to the first parent unit. The second parent unit is identical in structure to the first parent unit. The first infant sensor generates information related to the breathing and movement of an infant and transmits the information to the base. The base generates an alarm signal if the information indicates that the infant is not moving or breathing and transmits the alarm signal the second parent unit. The second infant sensor generates information related to the breathing and movement of an infant and transmits the information to the base. The base generates an alarm signal if the information indicates that the infant is not moving or breathing and transmits the alarm signal to the second parent unit. The first parent unit and the second parent unit are formed in the shape of a bracelet such that users of the system may wear the first parent unit and the second parent unit on the users' wrists. The base transmits information received from the first infant sensor and the second infant sensor to the server computer. The information received from the first infant sensor and the second infant sensor is retrievable from the server by a user utilizing the client computer.

In another embodiment of the invention, the invention comprises a first infant sensor, a base, a first parent unit, and a second parent unit. The infant sensor comprises a power source, a transducer, a sensor processor, a transceiver, a memory unit, a speaker, and a vibration generator. The base comprises a transceiver, a base memory unit, a base processor, a housing, a power source, a speaker, and a light indicator. The first parent unit comprises a power source, a transceiver, a parent processor, a light indicator, a speaker, and a vibration generator. In this embodiment, the second parent unit is identical in structure to the first parent unit. The first infant sensor generates information related to the breathing and movement of an infant and transmits the information to the base. The base generates an alarm signal if the information indicates that the infant is not moving or breathing and transmits the alarm signal to the second parent unit. In another embodiment of the invention, the invention further comprises a second infant sensor. The second infant sensor is identical in structure to the first infant sensor. The second infant sensor generates information related to the breathing and movement of an infant and transmits the information to the base. The base generates an alarm signal if the information indicates that the infant is not moving or breathing and transmits the alarm signal to the first parent unit. In another embodiment of the invention, the system further comprises a second parent unit. The second parent unit is identical in structure to the first parent unit. The first infant sensor generates information related to the breathing and movement of an infant and transmits the information to the base. The base generates an alarm signal if the information indicates that the infant is not moving or breathing and transmits the alarm signal to the second parent unit. The second infant sensor generates information related to the breathing and movement of an infant and transmits the information to the base. The base generates an alarm signal if the information indicates that the infant is not moving or breathing and transmits the alarm signal to the second parent unit.

In another embodiment of the invention, the system comprises a first infant sensor, a base, a first parent unit, a server computer, and a client computer. In this embodiment the base transmits information received from the infant sensor to the server computer. The information received from the infant sensor is retrievable from the server by a user utilizing the client computer. In another embodiment of the invention, the system further comprises a database connected to the server computer. In another embodiment of the invention, the infant sensor further comprises a memory unit, a speaker, and a vibration generator. In this embodiment, the base further comprises a speaker and a light indicator. If the sensor processor determines that the infant has not breathed or moved for at least fifteen seconds, the sensor processor activates the speaker to create an audible noise and activates the vibration generator to vibrate. In another embodiment of the invention, the base further comprises an infant sensor receptor.

In another embodiment of the invention, the system, with or without an infant sensor receptor, further comprises a second parent unit. The second parent unit is identical in structure to the first parent unit. The first infant sensor generates information related to the breathing and movement of an infant and transmits the information to the base. The base generates an alarm signal if the information indicates that the infant is not moving or breathing and transmits the alarm signal to the second parent unit.

In another embodiment of the invention, the system, with or without an infant sensor further comprises a second infant sensor. The second infant sensor is identical in structure to the first infant sensor. The second infant sensor generates information related to the breathing and movement of an infant and transmits the information to the base. The base generates an alarm signal if the information indicates that the infant is not moving or breathing and transmits the alarm signal to the first parent unit.

The invention may be organized such that the invention further comprises multiple parent units. In addition, the invention may be organized such that the invention further comprises multiple infant sensors. Multiple infant sensors may transmit information through the base to a single parent unit. One infant sensor may transmit information through the base to multiple parent units. Multiple infant sensors may transmit information through the base to multiple parent units.

The invention is also for a method of monitoring the breathing and movement of an infant. This method comprises obtaining information concerning the movement and breathing of an infant through a first infant sensor, transmitting the information to a base, generating an alarm signal in the base if the information indicates that the infant is not moving or breathing, and transmitting the alarm signal to a first parent unit. In this method the first infant sensor comprises a power source, a transducer, a sensor process, and a transceiver. In this method the base comprises a transceiver, a base memory unit, a base processor, and a housing. In this method, the first parent unit comprises a power source, a transceiver, a speaker, a vibration generator, and a light indicator.

In another embodiment of the invention, the method further comprises transmitting the information from the base to a server computer through a network connection and permitting a user to access the information on the server computer from a client computer through a network connection.

In another embodiment of the invention the method comprises obtaining information concerning the movement and breathing of an infant through a first infant sensor, transmitting the information to a base, generating an alarm signal in the base if the information indicates that the infant is not moving or breathing, and transmitting the alarm signal to a first parent unit, and transmitting the alarm signal to a second parent unit. In this method the first infant sensor comprises a power source, a transducer, a sensor process, and a transceiver. In this method the base comprises a transceiver, a base memory unit, a base processor, and a housing. In this method, the first parent unit comprises a power source, a transceiver, a speaker, a vibration generator, and a light indicator. In this method the second parent unit comprises a power source, a transceiver, a speaker, a vibration generator, and a light indicator.

In another embodiment of the invention the method comprises obtaining information concerning the movement and breathing of an infant through a first infant sensor, transmitting the information from the first infant sensor to a base, generating an alarm signal in the base if the information from the first infant sensor indicates that the infant is not moving or breathing, and transmitting the alarm signal to a first parent unit, obtaining information concerning the movement and breathing of an infant through a second infant sensor, transmitting the information from the second infant sensor to a base, generating an alarm signal in the base if the information from the second infant sensor indicates that the infant is not moving or breathing, and transmitting the alarm signal to a first parent unit. In this method the first infant sensor comprises a power source, a transducer, a sensor process, and a transceiver. In this method the second infant sensor comprises a power source, a transducer, a sensor processor, and a transceiver. In this method the base comprises a transceiver, a base memory unit, a base processor, and a housing. In this method, the first parent unit comprises a power source, a transceiver, a speaker, a vibration generator, and a light indicator.

In another embodiment of the invention the method comprises obtaining information concerning the movement and breathing of an infant through a first infant sensor, transmitting the information from the first infant sensor to a base, generating an alarm signal in the base if the information from the first infant sensor indicates that the infant is not moving or breathing, transmitting the alarm signal to a first parent unit, transmitting the alarm signal to a second parent unit, obtaining information concerning the movement and breathing of an infant through a second infant sensor, transmitting the information from the second infant sensor to a base, generating an alarm signal in the base if the information from the second infant sensor indicates that the infant is not moving or breathing, transmitting the alarm signal to a first parent unit, and transmitting the alarm signal to a second parent unit. In this method the first infant sensor comprises a power source, a transducer, a sensor process, and a transceiver. In this method the second infant sensor comprises a power source, a transducer, a sensor processor, and a transceiver. In this method the base comprises a transceiver, a base memory unit, a base processor, and a housing. In this method, the first parent unit comprises a power source, a transceiver, a speaker, a vibration generator, and a light indicator. In this method, the second parent unit comprises a power source, a transceiver, a speaker, a vibration generator, and a light indicator.

The base is the central operational unit of the system. The base houses the central processing and signaling components of the system. The housing for the base may be any type of firm material utilized in commercial products. Preferably the housing is made from a rigid thermoplastic material. Optionally, the housing may also be formed from any standard commercial grade metal. The infant sensor receptor on the base is a structural receptor for the infant sensor. When the system is not in use the infant sensor may be stored on the infant sensor receptor. The infant sensor receptor may be any positive structure protruding from the body of the base or negative shape recessing within the body of the base. In any structure, the infant sensor receptor is formed to complement and easily receive the infant sensor. Optionally the infant sensor receptor may receive multiple infant sensors.

The system may be structured so that the base communicates with a server computer in any embodiment. The server information sent to the server computer may be stored on a database which operates in conjunction with the server computer. A parent or caregiver may access the information on the server computer through a secure internet portal via client computer. The client computer may be any web-enabled device such as a laptop computer, a desktop computer, a tablet, or a cell phone. The parent or caregiver creates a specific user profile and password to restrict access to the information on the server computer. The parent or caregiver may view the system information in real time as relayed by the base. The parent or caregiver may also review the information received and stored over a specific period of time. The parent or caregiver may generate reports based on historical information received and stored by the system.

The base receives information from the infant sensor. If the base determines that the infant is not moving or breathing then the base transmits an alarm signal to the parent unit. Optionally, the base may also send an alarm signal through the server and generate an automated message which is sent to the client computer. This automated message may be sent as an email to the email address associated with the parent or caregiver's user profile. The automated message may be sent as a popup screen to be viewed on the client computer. The automated message may also be a text message sent to a mobile phone which is associated with the parent or caregiver's user profile.

### BRIEF DESCRIPTION OF THE DRAWINGS

FIG. 1 displays the view baby monitor and system

FIG. 2 is a schematic view of the sensor unit

FIG. 3 is a schematic view of the base unit

FIG. 4 is a schematic view of the parental unit

### DETAILED DESCRIPTION OF THE DRAWINGS

Although the present invention will be described with reference to the exemplary embodiments shown in the drawings, it should be understood that the present invention can be embodied in many alternate forms or embodiments. In addition, any suitable size, shape or type of elements or materials could be used.

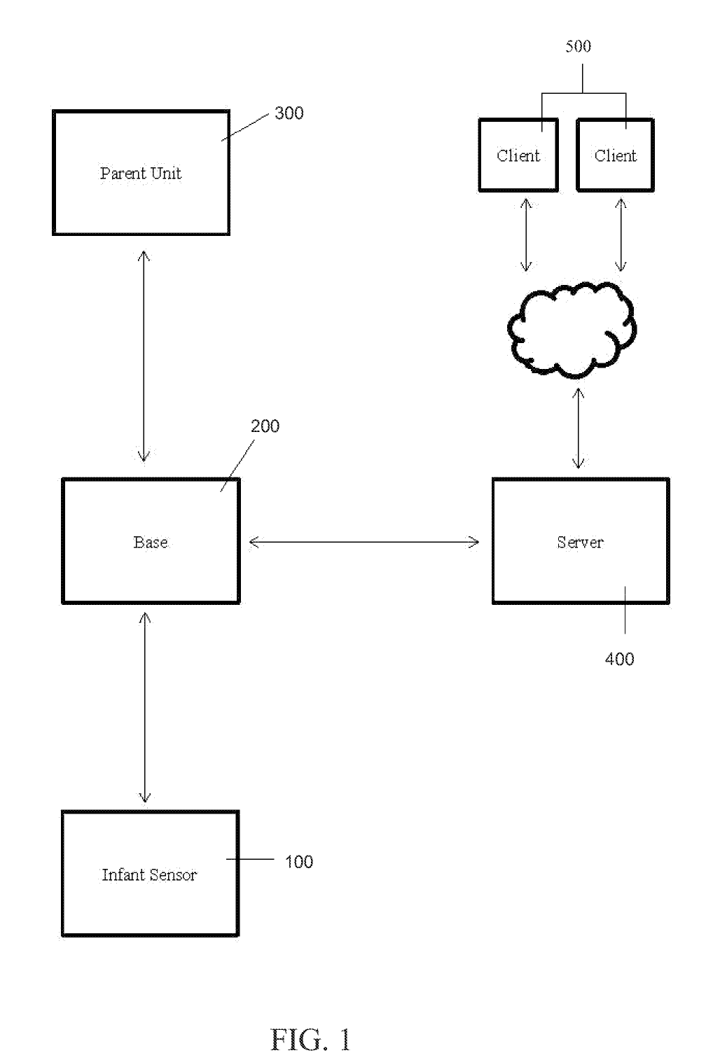

Referring to FIG. 1, the invention is an infant monitor system. The system comprises an infant sensor 100, a base 200, a parent unit 300, and a server 400. The infant sensor 100 is removably attached to an infant. Preferably, said sensor is attached to the clothing of said infant in the abdominal area. Said infant sensor 100 monitors the breathing and movement of the infant. Said infant sensor 100 relays data concerning the breathing and movement of the infant to said base 200 via a wireless signal. Preferably the wireless signal is a radio frequency. Said base 200 further relays data concerning the breathing rate and movement of the infant to said parent unit 300. Said base 200 is further connected to a server 400 via a public network such as the Internet. Said base 200 relays data concerning the breathing and movement of the infant to said server 400. Users may securely access the data concerning the breathing rate and movement of the infant that is stored on said server 400 via a public network such as the Internet via any of a number of client computers 500. Said client computers 500 may be any web-enabled electronic device, such as a computer, tablet, or smartphone. Preferably, a parent of an infant creates a password restricted user profile to restrict access to the data concerning the breathing rate and movement of the infant. Optionally, the server may be connected to a database for the storage of historical data concerning the breathing rate and movement of the infant.

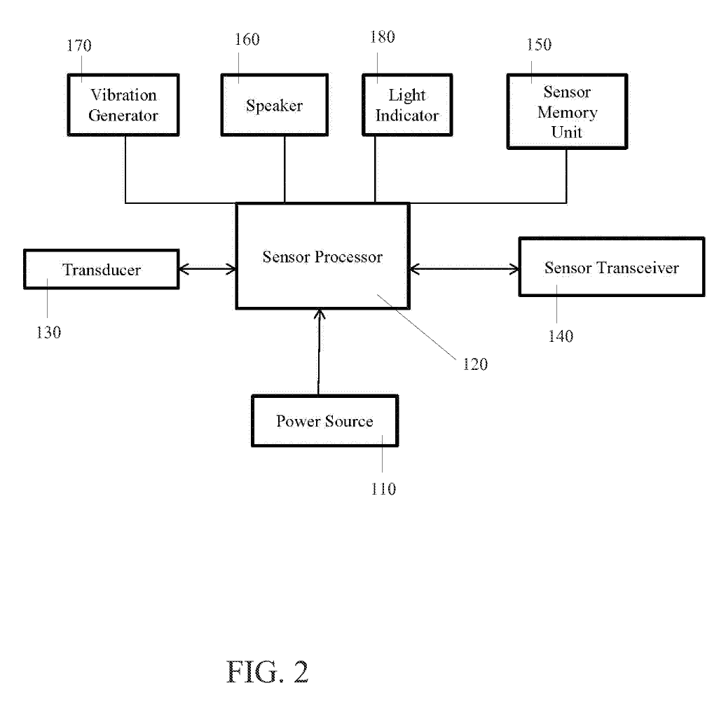

As shown in FIG. 2, said infant sensor 100 comprises a power source 110, a sensor processor 120, a transducer 130, a sensor transceiver 140, and a sensor memory unit 150. Said transducer 130 may be any type of electric transducer which converts the breathing movement and general movement of the infant into an electrical signal. In the preferred embodiment of the invention the transducer 130 is a piezoelectric film. The piezoelectric film is placed flat against the infant's abdomen. As the infant breaths, the normal movement of the infant causes the piezoelectric film to deform. This deformation causes the piezoelectric film to create an electrical impulse which is received and processed by said sensor processor 120. Said sensor processor 120 activates said sensor transceiver 140. Said sensor transceiver 140 transfers the information to said base 200. In the preferred embodiment, the transceiver 140 sends a signal to the base 200 through a Bluetooth signal. The infant sensor 100 may store data concerning the activation of the transducer 130 within the sensor memory unit 150.

In another embodiment, the infant sensor 100 further comprises a speaker 160 and a vibration generator 170. If the sensor processor 120 determines that the infant has not breathed or moved for fifteen seconds, the sensor processor 120 will activate the speaker 160 to generate an audible alarm. The sensor processor may also activate the vibration generator 170 to vibrate. The vibration and audible alarm acts as a disruptor to prompt the infant to begin breathing and moving. Optionally, the infant sensor may further comprise a light indicator 180. If the sensor processor 120 determines that the infant has not breathed or moved for fifteen seconds, the sensor processor 120 will activate the light indicator 180. The light from the light indicator 180 acts as a disruptor to prompt the infant to begin breathing and moving.

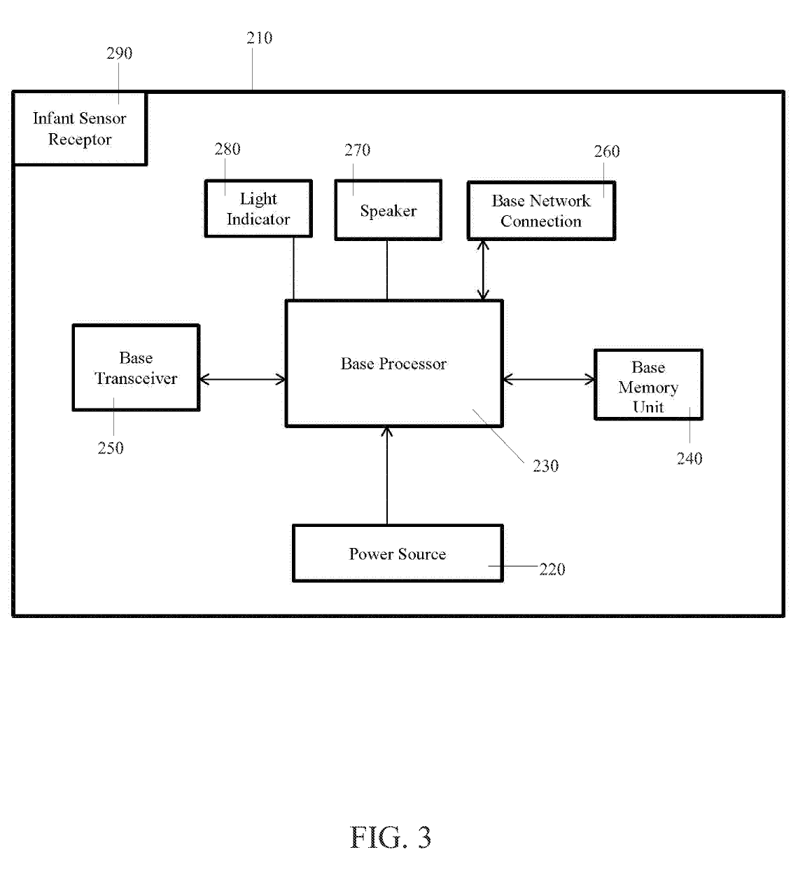

As shown in FIG. 3, said base 200 comprises a housing 210, a base processor 230, a base memory unit 240, a base transceiver 250, and a base network connection 260. The base 200 is connected to a power source 220. The power source 220 may be an external power source or an internal power source. The base network connection 260 may be any means for the base 200 to connect to a public network. The base network connection 260 may be an Ethernet receptor or a WiFi transmitter. The base network connection 260 allows the base 200 to transmit information to the server 400.

Optionally, in another embodiment the base 200 further comprises a light indicator 280. Optionally, the base 200 may contain more than one light indicator 280. In another embodiment the base 200 further comprises a speaker 270. The speaker 270 may generate an audible alarm when the base 200 fails to receive a signal from the infant sensor 100. Optionally, in other another embodiment, the base 200 further comprises an infant sensor receptor 290. The infant sensor 100 may be placed and stored on the infant sensor receptor 290 when the unit is not in use. Optionally, the infant sensor receptor 290 may contain a means for recharging battery of the infant sensor 100.

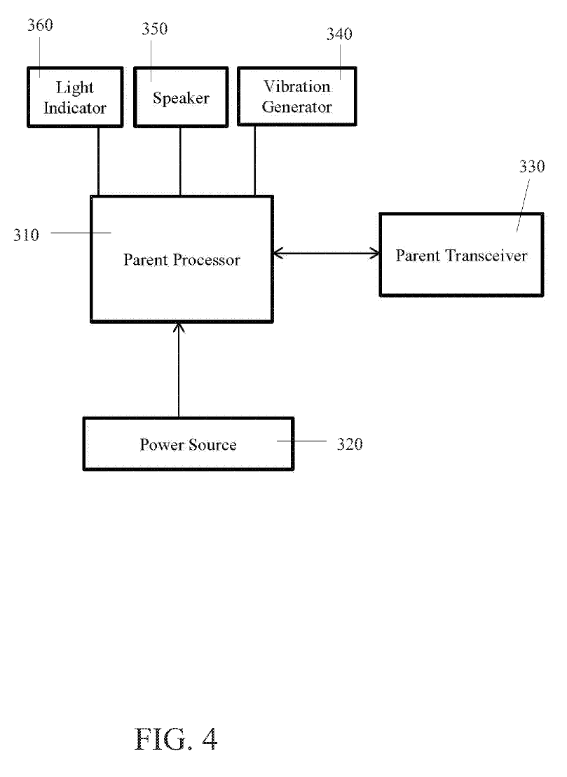

As shown in FIG. 4, the parent unit 300 comprises a parent processor 310, a power source 320, a parent transceiver 330, a vibration generator 340, and a speaker 350. Optionally the parent unit further comprises a light indicator 360. Preferably the power source 320 is a rechargeable battery. The parent unit 300 receives a signal from the base 200 through the parent transceiver 330. If signal indicates that the infant is not breathing or moving, then the parent processor 310 will activate the vibration generator 340 and speaker 350. The parent processor 310 will activate the speaker 350 to generate an audible alarm. The vibration and the audible alarm alert the parent to check on the infant. Optionally, the parent processor 310 may activate the light indicator 360 to flash an alarm when a signal is received that the infant is not breathing or moving.

1. An system for monitoring an infant comprising
A first infant sensor
Said infant sensor comprising
A power source
A transducer
a sensor processor
a transceiver
A base
Said base comprising
a transceiver
a base memory unit
a base processor
a housing
A first parent unit
Said parent unit comprising
A power source
A transceiver
A parent processor
Wherein said first infant sensor is removably attached to the infant
Wherein said first infant sensor generates information related to the breathing and movement of an infant
Wherein said first infant sensor transmits said information to said base
Wherein said base generates an alarm signal if said information indicates that the infant is not moving or breathing
Wherein said base transmits said alarm signal to said first parent unit

2. The system as in claim 1
Wherein said first infant sensor further comprises
A memory unit
Wherein said base further comprises
A power source
Wherein said first parent unit further comprises
A light indicator
A speaker
A vibration generator
Wherein said alarm signal is received by said parent processor
Wherein said parent processor activates said speaker in said parent unit to emit a sound, said light indicator in said parent unit to activate, and said vibration generator in said parent unit to vibrate.

3. The system as in claim 2
Wherein said first infant sensor further comprises
A speaker
A vibration generator
Wherein if said sensor processor determines that the infant has not breathed or moved for at least fifteen seconds, said sensor processor activates said speaker to create an audible noise and activates said vibration generator to vibrate
Wherein said base further comprises
A speaker
A light indicator
Wherein said alarm signal causes said base processor to activate said speaker in said base to emit an audible sound and said light indicator in said base to activate

4. The system as in claim 3
Wherein said first infant sensor further comprises a light indicator
Wherein if said sensor processor determines that the infant has not breathed or moved for at least fifteen seconds, said sensor processor activates said light indicator

5. The system as in claim 4
Wherein said base further comprises an infant sensor receptor

6. The system as in claim 5 further comprising
a second infant sensor
Wherein said second infant sensor is identical in structure to said first infant sensor
Wherein said second infant sensor generates information related to the breathing and movement of an infant
Wherein said second infant sensor transmits said information to said base
Wherein said base generates an alarm signal if said information indicates that the infant is not moving or breathing
Wherein said base transmits said alarm signal to said first parent unit a second parent unit
Wherein said second parent unit is identical in structure to said first parent unit
Wherein said first infant sensor generates information related to the breathing and movement of an infant
Wherein said first infant sensor transmits said information to said base
Wherein said base generates an alarm signal if said information indicates that the infant is not moving or breathing
Wherein said base transmits said alarm signal to said second parent unit
Wherein said second infant sensor generates information related to the breathing and movement of an infant
Wherein said second infant sensor transmits said information to said base
Wherein said base generates an alarm signal if said information indicates that the infant is not moving or breathing
Wherein said base transmits said alarm signal to said second parent unit
Wherein said first parent unit and said second parent unit are formed in the shape of a bracelet such that users of the system may wear said first parent unit and said second parent unit on the users' wrists
A server computer
A database connected to said server computer
A client computer
Wherein said base transmits information received from said first infant sensor and said second infant sensor to said server computer
Wherein said information received from said first infant sensor and said second infant sensor is retrievable from said server by a user utilizing said client computer

7. The system as in claim 3 further comprising a second parent unit
Wherein said second parent unit is identical in structure to said first parent unit
Wherein said first infant sensor generates information related to the breathing and movement of an infant
Wherein said first infant sensor transmits said information to said base
Wherein said base generates an alarm signal if said information indicates that the infant is not moving or breathing
Wherein said base transmits said alarm signal to said second parent unit

8. The system as in claim 3 further comprising a second infant sensor
Wherein said second infant sensor is identical in structure to said first infant sensor
Wherein said second infant sensor generates information related to the breathing and movement of an infant
Wherein said second infant sensor transmits said information to said base
Wherein said base generates an alarm signal if said information indicates that the infant is not moving or breathing
Wherein said base transmits said alarm signal to said first parent unit

9. The system as in claim 8 further comprising a second parent unit
Wherein said second parent unit is identical in structure to said first parent unit
Wherein said first infant sensor generates information related to the breathing and movement of an infant
Wherein said first infant sensor transmits said information to said base
Wherein said base generates an alarm signal if said information indicates that the infant is not moving or breathing
Wherein said base transmits said alarm signal to said second parent unit
Wherein said second infant sensor generates information related to the breathing and movement of an infant
Wherein said second infant sensor transmits said information to said base
Wherein said base generates an alarm signal if said information indicates that the infant is not moving or breathing
Wherein said base transmits said alarm signal to said second parent unit

10. The system as in claim 1 further comprising
A server computer
A client computer
Wherein said base transmits information received from said infant sensor to said server computer
Wherein said information received from said infant sensor is retrievable from said server by a user utilizing said client computer

11. The system as in claim 10 further comprising
A database connected to said server computer

12. The system as in claim 11
Wherein said infant sensor further comprises
A memory unit
A speaker
A vibration generator
Wherein said base further comprises
A speaker
A light indicator
Wherein if said sensor processor determines that the infant has not breathed or moved for at least fifteen seconds, said sensor processor activates said speaker to create an audible noise and activates said vibration generator to vibrate

13. The system as in claim 12
Wherein said base further comprises an infant sensor receptor

14. The system as in claim 12 further comprising a second parent unit
Wherein said second parent unit is identical in structure to said first parent unit
Wherein said first infant sensor generates information related to the breathing and movement of an infant
Wherein said first infant sensor transmits said information to said base
Wherein said base generates an alarm signal if said information indicates that the infant is not moving or breathing
Wherein said base transmits said alarm signal to said second parent unit

15. The system as in claim 12 further comprising a second infant sensor
Wherein said second infant sensor is identical in structure to said first infant sensor
Wherein said second infant sensor generates information related to the breathing and movement of an infant
Wherein said second infant sensor transmits said information to said base
Wherein said base generates an alarm signal if said information indicates that the infant is not moving or breathing
Wherein said base transmits said alarm signal to said first parent unit

16. The system as in claim 15 further comprising a second parent unit
Wherein said second parent unit is identical in structure to said first parent unit
Wherein said first infant sensor generates information related to the breathing and movement of an infant
Wherein said first infant sensor transmits said information to said base
Wherein said base generates an alarm signal if said information indicates that the infant is not moving or breathing
Wherein said base transmits said alarm signal to said second parent unit
Wherein said second infant sensor generates information related to the breathing and movement of an infant
Wherein said second infant sensor transmits said information to said base
Wherein said base generates an alarm signal if said information indicates that the infant is not moving or breathing
Wherein said base transmits said alarm signal to said second parent unit

17. A method for monitoring the breathing and movement of an infant comprising
Obtaining information concerning the movement and breathing of an infant through a first infant sensor
Said first infant sensor comprising
A power source
A transducer
a sensor processor
a transceiver
Transmitting said information to a base
Said base comprising
a transceiver
a base memory unit
a base processor
a housing
Generating an alarm signal in said base if said information indicates that the infant is not moving or breathing
Transmitting said alarm signal to a first parent unit
Said first parent unit comprising
A power source
A transceiver
A speaker
A vibration generator
A light indicator

18. The method as in claim 17 further comprising
Transmitting said information from said base to a server computer through a network connection
Permitting a user to access said information on said server computer from a client computer through a network connection

19. The method as in claim 17 further comprising
Transmitting said alarm signal to a second parent unit
Said second parent unit comprising
A power source
A transceiver
A speaker
A vibration generator
A light indicator

20. The method as in claim 19 further comprising
Obtaining information concerning the movement and breathing of an infant through a second infant sensor
Said second infant sensor comprising
A power source
A transducer
a sensor processor
a transceiver
Transmitting said information to said base
Generating an alarm signal in said base if said information indicates that the infant is not moving or breathing
Transmitting said alarm signal to said first parent unit
Transmitting said alarm signal to said second parent unit
